(19) United States
(12) Patent Application Publication
(10) Pub. No.: US 2011/0252384 A1
(43) Pub. Date: Oct. 13, 2011

(54) WIRELESS DISPLAY APPLICATION

(75) Inventors: Matthew A. Calman, Charlotte, NC (US); John C. Rukavina, Charlotte, NC (US); Jim E. Burgess, Charlotte, NC (US)

(73) Assignee: Bank of America Corporation, Charlotte, NC (US)

(21) Appl. No.: 12/757,655

(22) Filed: Apr. 9, 2010

(51) Int. Cl. G06F 3/14; G06F 9/44

(52) U.S. Cl. 715/864; 717/106

(57) ABSTRACT

Systems and methods are illustrated that relate to displaying an output screen from a mobile device on a monitor in communication with a computer through a wireless network. The systems and methods may include the steps of: connecting the mobile device to the computer via a network, converting an output screen from the mobile device into a transferrable command, sending the transferrable command to the computer via the network, receiving the transferrable command from the mobile device, translating the transferrable command into one of a plurality of monitor display screens, sending the one of the plurality of monitor display screens to a monitor in communication with the computer, and/or displaying the one of a plurality of monitor display screens on the monitor.

### TECHNICAL FIELD

Aspects of the disclosure relate to mobile devices and computer systems. More specifically, aspects of the disclosure relate to displaying an output screen from a mobile device on a monitor in communication with a computer through a wireless network.

### BACKGROUND

Mobile devices have a growing number of external software and applications available that can be loaded and installed onto these mobile devices. These external software and applications may include software and applications from any number of different categories, for example, professional, entertainment, games, utilities, social networking, music, productivity, banking, reference, travel, etc. With this growing number of software and applications available, there is an increased need for presentation of these software and applications. For example, a company may develop a new software or application package for a mobile device and may want to present this software as a marketing tool to a potential user group. Additionally, with this growing number of software and applications available, there is an increased need for training on this software and applications. For example, a company may develop a new software or application package and hold a training seminar or webinar to train potential or current users on how to most efficiently use the software or application. Additionally, during development of these new software and applications, the developers may have a need to troubleshoot and/or complete performance checks on the new software and applications.

The mobile devices currently have a small output screen, wherein it would be difficult to perform any of the above tasks, such as presenting, training, or troubleshooting the software and applications, especially to more than one person. There is a need in the art to be able to display on a larger screen what is currently on the small output screen for presenting, training, or troubleshooting the software and applications.

### BRIEF SUMMARY

The following presents a simplified summary of the disclosure in order to provide a basic understanding of some aspects. It is not intended to identify key or critical elements of the invention or to delineate the scope of the invention. The following summary merely presents some concepts of the disclosure in a simplified form as a prelude to the more detailed description provided below.

In accordance with aspects of the disclosure, a method for displaying an output screen associated with a mobile device on a monitor of a computer is disclosed. The method may include the steps of: connecting the mobile device to the computer via a network, identifying, using the mobile device, a transferrable command associated with an output screen of the mobile device, sending, using the mobile device, the transferrable command to the computer via the network, receiving, using the computer, the transferrable command from the mobile device, translating, using the computer, the transferrable command into one of a plurality of monitor display screens, sending, using the computer, the one of the plurality of monitor display screens to a monitor in communication with the computer, and displaying, using the computer, the one of a plurality of monitor display screens on the monitor. Additionally, one of the plurality of monitor display screens may be equivalent to the output screen from the mobile phone. In addition, aspects of the disclosure describe changing the output screen, wireless Bluetooth network and commands for the display applications that reside on the mobile device and the computer.

In another embodiment in accordance with aspects of the disclosure, one or more computer-readable medium storing computer-executable instructions is disclosed that, when executed by one or more processors, cause a system, which comprises a mobile device and a computer with a monitor, to perform steps comprising: connecting, using a processor on the mobile device, the mobile device to a computer over a wireless network; converting, using the processor on the mobile device, an output screen from the mobile device into a transferrable command; sending, using the processor on the mobile device, the transferrable command to the computer via the wireless network; receiving, using a processor on the computer, the transferrable command from the mobile device display application via the wireless network; translating, using the processor on the computer, the transferrable command into one of a plurality of monitor display screens that reside on the computer; sending, using the processor on the computer, the one of the plurality of monitor display screens to the monitor connected to the computer; and displaying, using the processor on the computer, the one of the plurality of monitor display screens on the monitor. Additionally, the one of the plurality of monitor display screens may be equivalent to the output screen on the mobile device. In addition, aspects of the disclosure describe changing the output screen, wireless Bluetooth network and commands for the display applications that reside on the mobile device and the computer.

One skilled in the art will appreciate that one or more of the aforementioned methods and features may be embodied as computer-executable instructions stored on a computer-readable medium and executed by a processor.

### BRIEF DESCRIPTION OF THE DRAWINGS

The present disclosure is illustrated by way of example and not limited in the accompanying figures in which like reference numerals indicate similar elements and in which:

FIG. 1 illustrates a schematic diagram of a general-purpose digital computing environment in which various aspects of this invention may be implemented;

FIG. 2 illustrates one embodiment of a system in accordance with aspects of this invention;

FIGS. 3A and 3B represent a flowchart illustrating the system from FIG. 2 in accordance with aspects of this invention;

FIG. 4 illustrates another embodiment of a system in accordance with aspects of this invention; and

FIGS. 5A and 5B represent a flowchart illustrating the system from FIG. 4 in accordance with aspects of this invention.

### DETAILED DESCRIPTION

In accordance with various aspects of the disclosure, systems and methods are illustrated involving mobile devices and computer systems. More specifically, aspects of the disclosure relate to displaying an output screen from a mobile device on a monitor in communication with a computer through a wireless network.

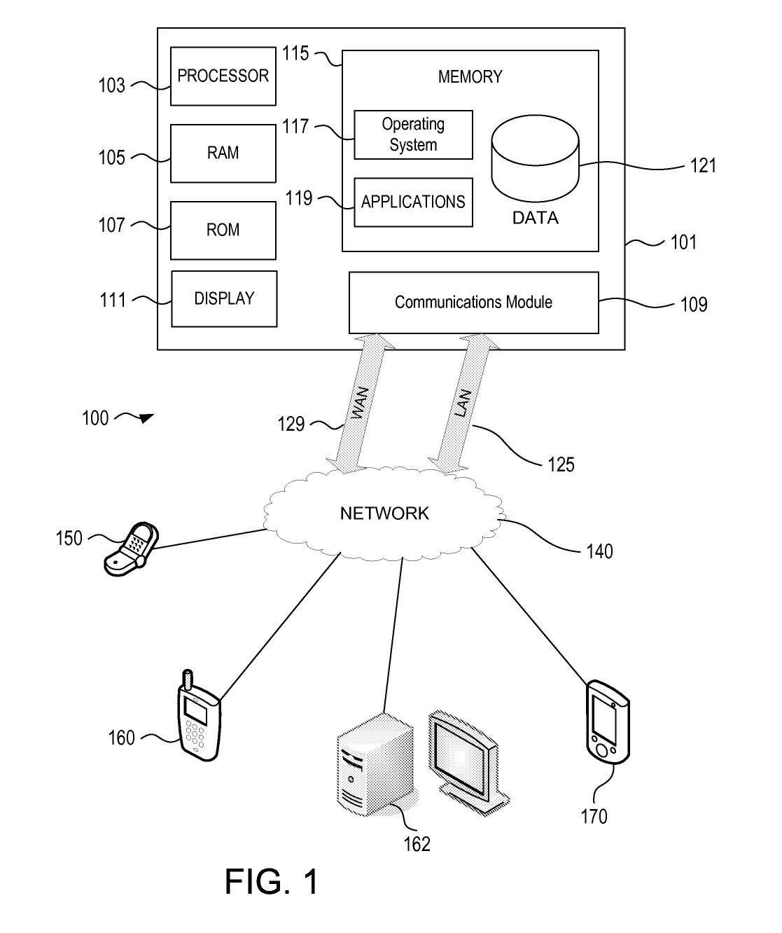

FIG. 1 illustrates an example of a suitable computing system environment 100 that may be used according to one or more illustrative embodiments of the invention. The computing system environment 100 is only one example of a suitable computing environment and is not intended to suggest any limitation as to the scope of use or functionality of the invention. The computing system environment 100 should not be interpreted as having any dependency or requirement relating to any one or combination of components illustrated in the computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile devices, mobile phones, cell phones, multiprocessor systems, microprocessor-based systems, set top boxes, programmable consumer electronics, network PCs, minicomputers, mainframe computers, distributed computing environments that include any of the above systems or devices, and the like.

Aspects of the invention may be described in the general context of computer-executable instructions, such as program modules, being executed by a mobile device or a computer. Generally, program modules include routines, programs, objects, components, data structures, etc. that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

FIG. 1 illustrates a block diagram of a generic computing device 101 (e.g., a computer) in computing environment 100 that may be used according to an illustrative embodiment of the disclosure. The computer 101 may have a processor 103 for controlling overall operation of the computer 101 and its associated components, including RAM 105, ROM 107, communications module 109, and memory 115. The computing environment described herein may be used with various aspects of the systems and methods described herein.

The communications module 109 may include a microphone, mouse, keypad, touch screen, scanner, optical reader, and/or stylus (or other input device(s)) through which a user of the computer 101 may provide input, and also may include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of the computer executable instructions may be embodied in hardware or firmware (not shown).

The computer 101 may operate in a networked environment supporting connections. FIG. 1 also includes an example communication network 140 with a number of computers and devices including mobile communication device 150, mobile phone 160, personal digital assistant (PDA) or mobile computer 162, and personal computer (PC) 170 may communicate with one another and with other devices through the network 140. The network 140 may include wired and wireless connections and network elements, and connections over the network may include permanent or temporary connections. Communication through the network 140 is not limited to the illustrated devices and may include additional mobile or fixed devices such as a video storage system, an audio/video player, a digital camera/camcorder, a tablet computer, a positioning device such as a GPS (Global Positioning System) device or satellite, a television, a radio broadcasting receiver, a set-top box (STB), a digital video recorder, remote control devices and any combination thereof.

Although shown as a single network in FIG. 1 for simplicity, the network 140 may include multiple networks that are interlinked so as to provide internetworked communications. Such networks may include one or more private or public packet-switched networks, e.g. the Internet, one or more private or public circuit-switched networks, e.g. a public switched telephone network, a cellular network configured to facilitate communications to and from mobile communication devices 150-170, e.g. through use of base stations, mobile switching centers, etc., a short or medium range wireless communication connection, e.g. Bluetooth®, ultra wideband (UWB), infrared, WiBree, wireless local area network (WLAN) according to one or more versions of Institute of Electrical and Electronics Engineers (IEEE) standard no. 802.11), or a high-speed wireless data network such as Evolution-Data Optimized (EV-DO) networks, Universal Mobile Telecommunications System (UMTS) networks, Long Term Evolution (LTE) networks or Enhanced Data rates for GSM Evolution (EDGE) networks. Devices 150-170 may use various communication protocols such as Internet Protocol (IP), Transmission Control Protocol (TCP), Simple Mail Transfer Protocol (SMTP) among others known in the art. Various messaging services such as Short Messaging Service (SMS) and/or Multimedia Message Service (MMS) may also be included.

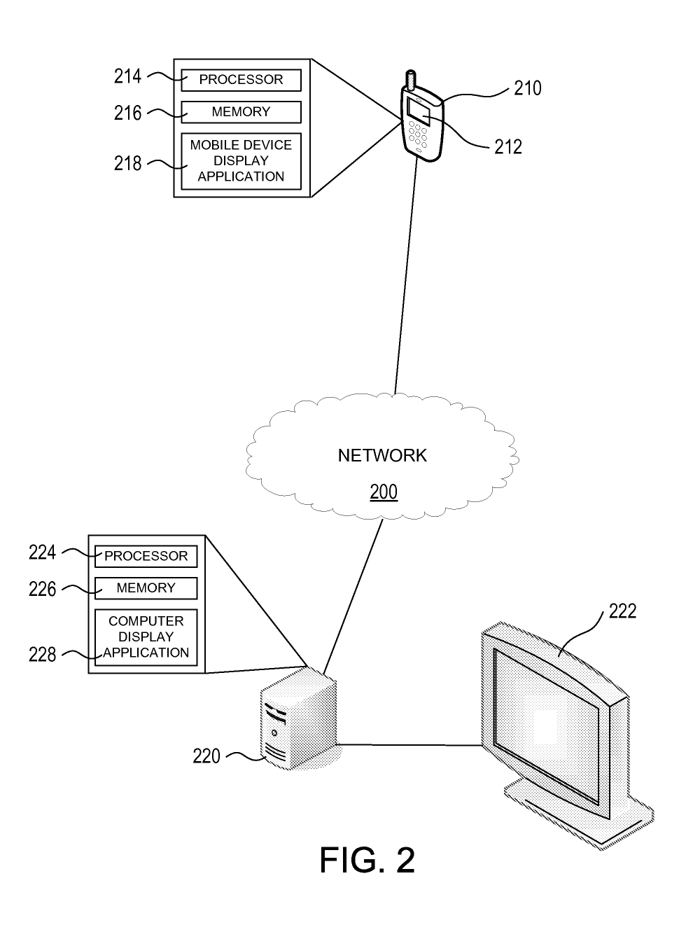

FIG. 2 illustrates one embodiment of a system for a mobile phone display application in accordance with aspects of the disclosure. The system as shown in FIG. 2 allows a user to view the output screen 212 of a mobile device 210 on a monitor or larger output screen 222. The system as shown in FIG. 2 may include a mobile device 210 and a computer 220. The mobile device 210 may be one of many different mobile devices without departing from this invention, to include cellular phones, mobile phones, remote control units, video storage systems, an audio/video playing, a digital camera/camcorder, a tablet computer, a positioning device such as a GPS device or satellite, a television, a PDA, a radio broadcasting receiver, a set-top box, a digital video recorder, and any combination thereof, etc. The mobile device 210 may include an output screen 212. The output screen 212 may display various information, data, and screens for the mobile device. Additionally, the output screen 212 may change as the user provides input to the mobile device 210 or performs operations on the mobile device 210, thereby changing the output screen 212. The output screen 212 may include various different screens, such as, for example, a home screen, a setup screen, a messaging screen, a dialing or phone screen, and/or a utilities screen, etc.

Generally, the mobile device 210 may also include a processor 214 for controlling overall operation of the mobile device 210 and its associated components, including memory 216. Software or applications may be stored within memory 216 and/or other storage to provide instructions to the processor 214 for enabling the mobile device 210 to perform various functions. For example, the memory 216 may store software used by the mobile device 210, such as a mobile device display application 218 that includes computer executable instructions. Alternatively, some or all of computer executable instructions may be embodied in hardware or firmware (not shown). The mobile device display application 218 may be downloaded or installed by the user on to the mobile device 210. The mobile device display application 218 may also be native to the mobile device 210 without departing from this invention. The mobile device display application 218 may be written using j2me commands on the mobile device 210. In additional examples, the mobile device display application 218 may be written using any high level mobile programming language on the mobile device 210.

The mobile device 210 may be in communication with a computer 220 or computing device by a network 200. The computer 220 may include any of the following without departing from this invention: personal computer (PC), mobile communication device, mobile phone, and personal digital assistant (PDA) or mobile computer. The computer 220 may include a processor 224 for controlling overall operation of the computer 220 and its associated components, including memory 226. Software or applications may be stored within memory 226 and/or other storage to provide instructions to the processor 224 for enabling the computer 220 to perform various functions. For example, the memory 226 may store software used by the computer 220, such as a computer display application 228 that includes computer executable instructions. Alternatively, some or all of computer executable instructions may be embodied in hardware or firmware (not shown). The computer display application 228 may be downloaded or installed by the user on to the computer 220. The computer display application 228 may also be native to the computer 220 without departing from this invention. The computer display application 228 may be written using Microsoft C# code on the computer 220. In additional examples, the computer display application 228 may be capable of using an high level programming language on the computer 220. The mobile device display application 218 and the computer display application 228 may be identical or similar applications, with the only difference being that they are written in different code.

The mobile device 210 and the computer 220 may communicate with one another and with other devices through the network 200. The network 200 may include a short or medium range wireless communication connection between the mobile device 210 and the computer 220, e.g. Bluetooth®, ultra wideband (UWB), infrared, WiBree, WLAN, or a high-speed wireless data network, UMTS networks, LTE networks, or EDGE networks. In accordance with various aspects of this invention, the network 200 may include wired and wireless connections and network elements, and connections over the network may include permanent or temporary connections.

Additionally, the network 200 may include multiple networks that are interlinked so as to provide internetworked communications. Such networks may include one or more private or public packet-switched networks, e.g. the Internet, one or more private or public circuit-switched networks, e.g. a public switched telephone network, a cellular network configured to facilitate communications to and from the mobile device 210 to the computer 220 through use of base stations, mobile switching centers, etc., a short or medium range wireless communication connection, e.g. Bluetooth®, ultra wideband (UWB), infrared, WiBree, WLAN, or a high-speed wireless data network, UMTS networks, LTE networks or EDGE networks.

As further illustrated in FIG. 2, the computer 220 may be in communication with a monitor 222 or display apparatus. The monitor 222 may be a large display apparatus, thereby being capable of displaying to a large audience of people. The monitor 222 or display apparatus may be in communication with the computer 220 through wired or wireless connections and network elements, or connections between the monitor 222 and the computer 220 may include permanent or temporary connections. The monitor 222 will be configured to display the same display as the output screens 212 from the mobile device 210, as will be explained below. The monitor 222 may also represent a monitor system without departing from this invention. One such example of a monitor system is a projector and a screen. In this example, the computer 210 may be in communication with a projector capable of projecting the display to a large screen.

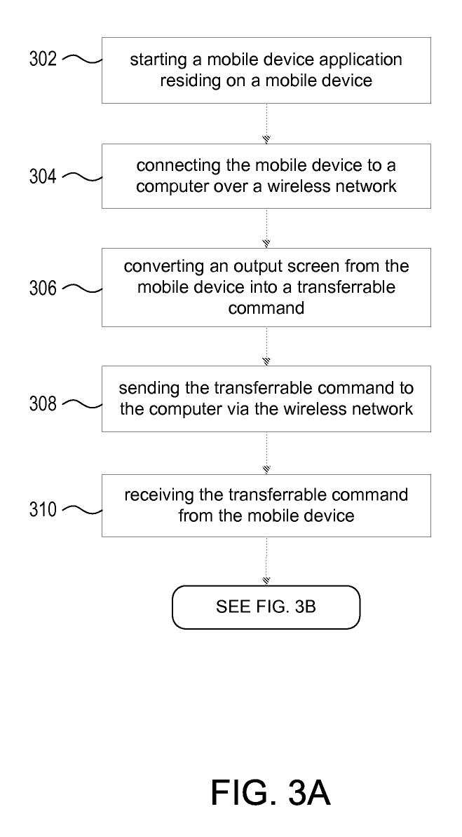

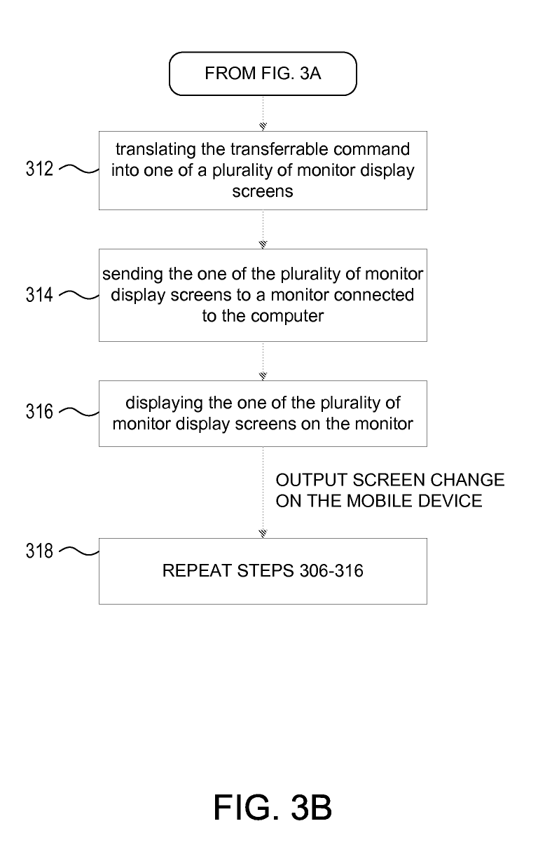

FIGS. 3A and 3B represent a flowchart illustrating one embodiment of a method in accordance with aspects of this invention. One or more aspects of the method may be implemented using a system (e.g., the system illustrated in FIG. 2). In step 302, the system starts a mobile device display application 218 residing on the mobile device 210. The mobile device display application 218 may reside within the mobile device as described above. For example, the mobile device display application 218 may be downloaded or installed by the user on to the mobile device 210. Alternatively, the mobile device display application 218 may also be native to the mobile device 210. The user may start the mobile device display application 218 by pressing a button or a button sequence on the mobile device 210, thereby loading and/or starting the mobile device display application 218. Additionally, the mobile device display application 218 may start automatically as will be explained below in more detail.

In step 304, after the mobile device display application 218 starts, the mobile device 210 connects to the computer 220 over the network 200. As was explained above, the network 200 may include wired and wireless connections and network elements, and connections over the network may include permanent or temporary connections. Additionally, the network 200 may include multiple networks that are interlinked so as to provide internetworked communications.

In step 306, the mobile device display application 218 converts an output screen 212 from the mobile device 210 into a transferrable command. The mobile device display application 218 may determine the output screen 212 and then select or convert that output screen 212 to a corresponding transferrable command. Each output screen 212 may correspond to one separate and different transferrable command. The transferrable command is capable of being sent through the network 200 to the computer 220. For example, when the “home screen” is output from the mobile device 210, the mobile device display application 218 converts the “home screen” output screen 212 to the “home screen” transferrable command.

In step 308, the mobile device display application 218 sends the transferrable command to the computer 220 via the network 200. For example, the mobile device display application 218 sends the “home screen” transferrable command to the computer 220. In step 310, the computer 220 and the computer display application 228 receives the transferrable command from the mobile device 210. For example, the computer 220 and computer display application 228 receive the “home screen” transferrable command from the mobile device 210 over the network 200.

In step 312, after the transferrable command is sent by the mobile device display application 218 and received by the computer display application 228, the computer display application 228 translates the transferrable command into one of a plurality of monitor display screens that reside within the computer display application 228. Each transferrable command may correspond to one monitor display screen. Each of the different monitor display screens may be included as part of the computer display application 228 for each different kind of model and type of mobile device 210 that is supported by this wireless display application system.

For example, for a certain Nokia mobile device, there may be 20 different output screens 212 capable of being displayed on the mobile device 210. Therefore, the mobile device display application 218 will include 20 different and separate transferrable commands that correspond to 20 different and separate monitor display screens that reside within the computer display application 228. Thereby, when the “home screen,” for example, is the output screen 212, the “home screen” transferrable command is sent to the computer 220. The computer display application 228 then translates the “home screen” transferrable command to the “home screen” monitor display screen.

In another example, for a certain Motorola mobile device, there may be 27 different output screens 212 capable of being displayed on the mobile device 210. Therefore, the mobile device display application 218 will include 27 different and separate transferrable commands that correspond to 27 different and separate monitor display screens that reside within the computer display application 228. For each model and type of phone, the mobile device display application 218 and the computer display application 228 may be different and may need to be changed for different mobile devices 210. Without departing from this invention, the mobile device display application 218 and the computer display application 228 may include transferrable commands and monitor display screens for various multiple models and types of phones to make the applications compatible with a variety of different models and types of phones.

In step 314, after the transferrable command is translated into the monitor display screen, the computer display application 228 sends the monitor display screen to a monitor 222 or monitor system that is in communication with the computer 220. For example, the computer display application 228 sends the “home screen” monitor display screen to the monitor 222. As was described above, the monitor 222 may be in communication with the computer 220 through wired or wireless connections and network elements, or connections between the monitor 222 and the computer 220 may include permanent or temporary connections.

In step 316, the monitor 222 displays the one of the plurality of monitor display screens on the monitor. The monitor display screen corresponds to the proper output screen 212 as output by the mobile device 210. For example, the monitor displays the “home screen” monitor display screen on the monitor 222, thereby matching the “home screen” output screen 212 from the mobile device 210.

In step 318, if the output screen 212 changes, (i.e., from user input or automatically from the system) a portion of the method steps repeat, starting with step 306 through step 316. For example, if the “home screen” is being output on the mobile device 210 and the user changes to the “settings screen” on the mobile device 210, process steps 306-316 repeat. First the mobile device display application 218 converts the “settings screen” to a transferrable command for “settings screen.” Next, the mobile device display application 218 sends the “setting screen” transferrable command to the computer 220. Next, the computer 220 receives the “setting screen” transferrable command from the mobile device 210 and the computer display application 228 translates the “setting screen” transferrable command into the “setting screen” monitor display screen. Next, the computer display application 228 sends the “setting screen” monitor display screen to the monitor 222 in communication with the computer 220. And finally, the “setting screen” monitor display screen is displayed on the monitor 222, thereby matching the “setting screen” on the output screen 212 of the mobile device 210.

In addition, the mobile device display application 218 may start automatically when the mobile device 210 detects the computer display application 228 on the computer 220 within a range. If this detection occurs, the user may verify that the user wants to run or start the mobile device display application 218. For example, the computer display application 228 may detect the mobile device 210 is within range via the Bluetooth® connection with the mobile device 210. The computer display application 228 may then send a command or instruction to the mobile device 210, thereby automatically starting the mobile device display application 218. This automatic starting of the mobile device display application 218 may be a user setting that is configurable by the user during set-up.

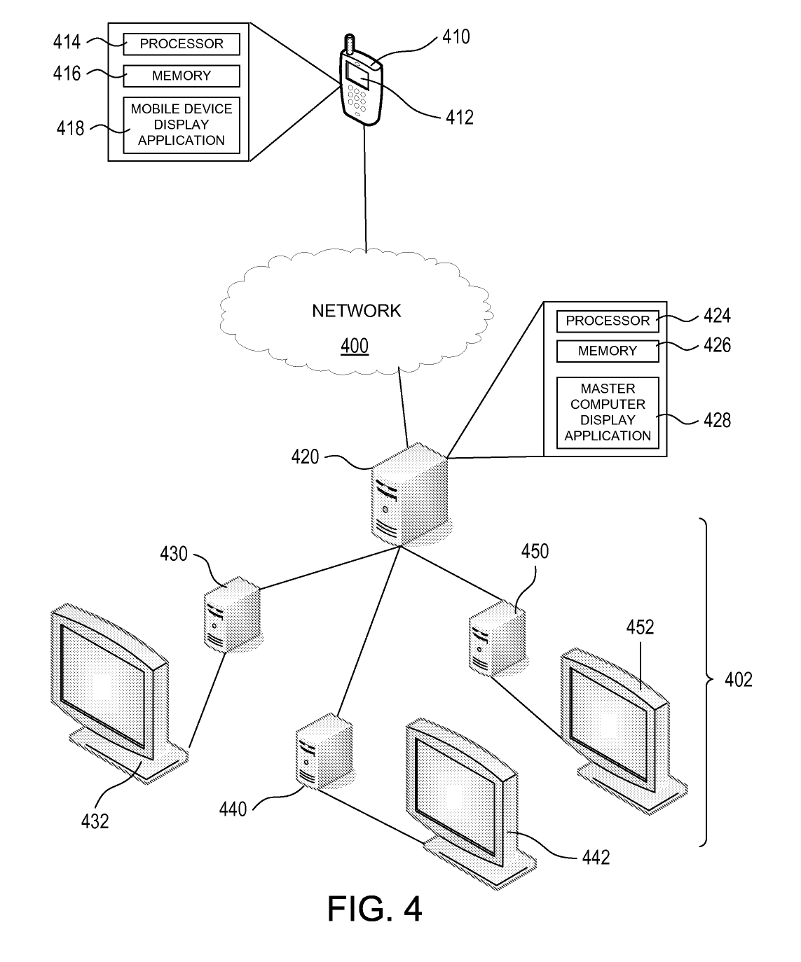

FIG. 4 illustrates another embodiment of a system in accordance with aspects of the disclosure. The system as shown in FIG. 4 allows a user to view the output screen 412 of a mobile device 410 on multiple monitors or larger output screens. The system as shown in FIG. 4 may include a mobile device 410 and a master computer 420 and a display network 402. The mobile device 410 may be one of many different mobile devices without departing from this invention, to include cellular phones, mobile phones, remote control units, video storage system, an audio/video player, a digital camera/camcorder, a tablet computer, a positioning device such as GPS device or satellite, a television, PDA, a radio broadcasting receiver, a set-top box, a digital video recorder, and any combination thereof, etc. The mobile device 410 may include an output screen 412. The output screen 412 may display various information, data, and screens for the mobile device 410. Additionally, the output screen 412 may change as the user provides input to the mobile device 410, thereby changing the output screen 412. The output screen 412 may include various different screens, such as, for example, a home screen, a setup screen, a messaging screen, a dialing or phone screen, and/or a utilities screen, etc.

Generally, the mobile device 410 may also include a processor 414 for controlling overall operation of the mobile device 410 and its associated components, including memory 416. Software or applications may be stored within memory 416 and/or other storage to provide instructions to the processor 414 for enabling the mobile device 410 to perform various functions. For example, the memory 416 may store software used by the mobile device 410, such as a mobile device display application 418 that includes computer executable instructions. Alternatively, some or all of computer executable instructions may be embodied in hardware or firmware (not shown). The mobile device display application 418 may be downloaded or installed by the user on to the mobile device 410. The mobile device display application 418 may also be native to the mobile device 410 without departing from this invention. The mobile device display application 418 may be written using j2me commands on the mobile device 410. In additional examples without departing from the invention, the mobile device display application 418 may be written using any high level mobile programming language on the mobile device 410.

The mobile device 410 may be in communication with a master computer 420 or computing device by a network 400. The master computer 420 may include any of the following without departing from this invention: personal computer (PC), mobile communication device, mobile phone, personal digital assistant (PDA), mobile computer, or tablet computer. The master computer 420 may include a processor 424 for controlling overall operation of the master computer 420 and its associated components, including memory 426. Software or applications may be stored within memory 426 and/or other storage to provide instructions to the processor 424 for enabling the master computer 420 to perform various functions. For example, the memory 426 may store software used by the master computer 420, such as a master computer display application 428 that includes computer executable instructions. Alternatively, some or all of computer executable instructions may be embodied in hardware or firmware (not shown). The master computer display application 428 may be downloaded or installed by the user on to the master computer 420. The master computer display application 428 may also be native to the master computer 420 without departing from this invention. The master computer display application 428 may be written using Microsoft C# code on the master computer 420. In additional examples without departing from the invention, the master computer display application 428 may be capable of using any high level programming language on the master computer 420. The mobile device display application 418 and the master computer display application 428 may be identical or similar applications, with the only difference being that they are written in different code.

The mobile device 410 and the master computer 420 may communicate with one another and with other devices through the network 200. The network 200 may include a short or medium range wireless communication connection between the mobile device 410 and the master computer 420, e.g., Bluetooth®, ultra wideband (UWB), infrared, WiBree, WLAN, or a high-speed wireless data network, UMTS networks, LTE networks, or EDGE networks. Without departing from this invention, the network 200 may include wired and wireless connections and network elements, and connections over the network may include permanent or temporary connections. Additionally, the network 200 may include multiple networks that are interlinked so as to provide internetworked communications.

As further illustrated in FIG. 4, the master computer 420 may be in communication with a display network 402. The master computer 420 may be in communication with the display network 402 via a Bluetooth®, wireless or wired connection, between the master computer 420 and the computers 430, 440, 450 on the display network 402. Without departing from this invention, the connection between the master computer 420 and the display network 402 may include wired and wireless connections and network elements, while also including permanent or temporary connections.

The display network 402 may be made up of a plurality of different computers 430, 440, 450 in communication with monitors 432, 442, 452 or monitor systems. The monitors 432, 442, 452 may be a large display apparatus, thereby being capable of displaying to a large audience of people. Each of the monitors 432, 442, 452 may be in communication with the corresponding computer 430, 440, 450 through wired or wireless connections and network elements, or connections between the monitor 432, 442, 452 and the computer 430, 440, 450 may include permanent or temporary connections. The monitors 432, 442, 452 will be configured to display the same display as the output screen 412 from the mobile device 410, as will be explained below. The monitors 432, 442, 452 may also represent a monitor system without departing from this invention. One such example of a monitor system is a projector and a screen. In this example, the computer 430, 440, 450 may be in communication with a projector, which would then be capable of projecting the display to a large screen.

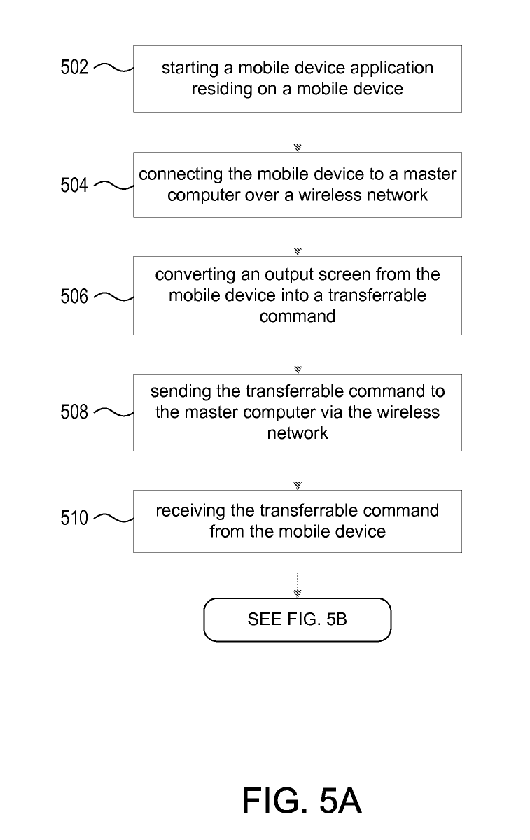

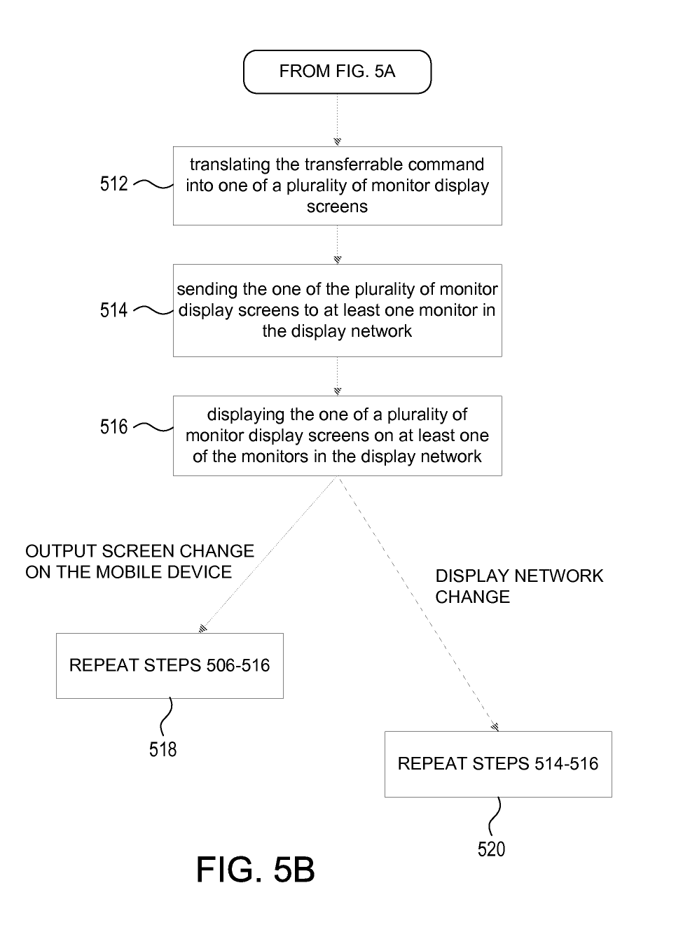

FIGS. 5A and 5B represent a flowchart illustrating one embodiment of a method in accordance with aspects of this invention. One or more aspects of the method may be implemented using a system (e.g., the system illustrated in FIG. 4). In step 502, the system starts a mobile device display application 418 residing on the mobile device 410. For example, the mobile device display application 418 may be downloaded or installed by the user onto the mobile device 410. Alternatively, the mobile device display application 418 may also be native to the mobile device 410. The user may start the mobile device display application 418 by pressing a button sequence on the mobile device 410, thereby loading and/or starting the mobile device display application 418. Additionally, the mobile device display application 418 may start automatically as explained above.

In step 504, after the mobile device display application 418 starts, the mobile device 410 connects to the master computer 420 over the network 400. As was explained above, the network 400 may include wired and wireless connections and network elements, and connections over the network may include permanent or temporary connections. Additionally, the network 400 may include multiple networks that are interlinked so as to provide internetworked communications.

In step 506, the mobile device display application 418 converts a output screen 412 from the mobile device 410 into a transferrable command. The mobile device display application 418 may determine the output screen 412 and then convert that specific output screen 412 to a corresponding transferrable command. Each output screen 412 may correspond to one separate and different transferrable command. The transferrable command is capable of being sent through the network 400 to the master computer 420. For example, when the “home screen” is output from the mobile device 410, the mobile device display application 418 converts the “home screen” output screen 412 to the “home screen” transferrable command.

In step 508, the mobile device display application 418 sends the transferrable command to the master computer 420 via the network 400. For example, the mobile device display application 418 sends the “home screen” transferrable command to the master computer 420. In step 510, the master computer 420 and the master computer display application 428 receive the transferrable command from the mobile device 410. For example, the master computer 420 and the master computer display application 428 receive the “home screen” transferrable command from the mobile device 410 over the network 400.

In step 512, after the transferrable command is sent by the mobile device display application 418 and received by the master computer 420, the master computer display application 428 translates the transferrable command into one of a plurality of monitor display screens that reside within the master computer display application 428. Each transferrable command may correspond to one monitor display screen. Each of the different monitor display screens may be included as part of the master computer display application 428 for each different kind of model and type of mobile device 410 that is supported by this wireless display application system. Thereby, when the “home screen,” for example, is the output screen 412, the “home screen” transferrable command is sent to the master computer 420. The master computer display application 428 then translates the “home screen” transferrable command to the “home screen” monitor display screen.

For each model and type of phone, the mobile device display application 418 and the master computer display application 428 may be different and may need to be changed for different mobile devices. Without departing from this invention, the mobile device display application 418 and the master computer display application 428 may include transferrable commands and monitor display screens for various multiple models and types of phones to make the applications compatible with a variety of different models and types of phones.

In step 514, after the transferrable command is translated into the monitor display screen, the master computer display application 428 sends the monitor display screen to at least one display 432, 442, 452 in the display network 402. During this step, the master computer display application 428 and master computer 420 determine which display 432, 442, 452 should receive the monitor display screen. The master computer display application 428 and master computer 420 may make this determination using a number of factors. One such factor may be the location of the mobile device 410 in relation to any one of the displays 432, 442, 452. For example, during a presentation, a user may be holding the mobile device 410 and moving around the room, thereby moving next to various different displays 432, 442, 452 throughout the presentation. While the user moves to different locations in relation to each of the displays 432, 442, 452, the master computer display application 428 sends the given monitor display screen to the proper display 432, 442, 452. Other factors that may affect which display or displays are used for the monitor display screen may be timing of the presentation, set-up by the user, etc. Any number of different factors may be used to control the master computer application 428 in sending the monitor display screen to one or more displays 432, 442, 452. For example, the computer display application 428 sends the “home screen” monitor display screen to one or more of the monitors 432, 442, 452. As was described above, the monitors 432, 442, 452 may be in communication with the computer 430, 440, 450 through wired or wireless connections and network elements, or connections between the monitor 432, 442, 452 and the computer 430, 440, 450 may include permanent or temporary connections.

In step 516, the “selected” one or more monitors 432, 442, 452 display the one of the plurality of monitor display screens on the selected one or more monitors 432, 442, 452. The monitor display screen corresponds to the proper output screen 412 as output by the mobile device 410. For example, one or more monitors 432, 442, 452 display the “home screen” monitor display screen on the selected one or more monitors 432, 442, 452, thereby matching the “home screen” output screen from the mobile device 410.

In step 518, if the output screen 412 changes, the process repeats, starting with step 506 through step 516. For example, if the “home screen” is being output on the mobile device 410 and the user changes to the “settings screen” on the mobile device 410, process steps 506-516 repeat. First the mobile device display application 418 converts the “settings screen” to a transferrable command for “settings screen.” Next, the mobile device display application 418 sends the “setting screen” transferrable command to the master computer 420. Next, the master computer 420 receives the “setting screen” transferrable command from the mobile device 410 and translates the “setting screen” transferrable command into the “setting screen” monitor display screen. Next, the master computer display application 428 sends the “setting screen” monitor display screen to at least one monitor 432, 442, 452 in the display network 402. And finally, the “setting screen” monitor display screen is displayed on at least one of the monitors 432, 442, 452 in the display network 402, thereby matching the “setting screen” on the output screen 412 of the mobile device 410.

In step 520, if the display network 402 factor changes, a portion of the steps repeat, namely steps 514 and 516. For example, if the “home screen” is being displayed on monitor 432, and the user moves to a different location, thereby triggering monitor 452 to be used, steps 514 and 516 will be repeated. First, as the master computer 420 and master computer application 428 determine that there is a display network 402 factor change, such as location, user settings, time, etc., the master computer application 428 sends the “home screen” monitor display screen to a different display, such as monitor 452, thereby effectively stopping the signal from being sent to monitor 432. Next, monitor 452 displays the “home screen” monitor display screen, until either the output screen 412 on the mobile device 410 changes, or the display network 402 changes again.

Although not required, one of ordinary skill in the art will appreciate that various aspects described herein may be embodied as a method, a processing system, or as a computer-readable medium storing computer-executable instructions. Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure. In addition, the steps described herein may be performed using a processor executing computer-executable instructions stored on a computer-readable medium.

I/we claim:

1. One or more computer-readable medium storing computer-executable instructions that, when executed by one or more processors, cause a system, which comprises a mobile device and a computer with a monitor, to perform steps comprising:
connecting, using a processor on the mobile device, the mobile device to a computer over a wireless network,
converting, using the processor on the mobile device, an output screen from the mobile device into a transferrable command, and
sending, using the processor on the mobile device, the transferrable command to the computer via the wireless network; and
receiving, using a processor on the computer, the transferrable command from the mobile device display application via the wireless network,
translating, using the processor on the computer, the transferrable command into one of a plurality of monitor display screens that reside on the computer,
sending, using the processor on the computer, the one of the plurality of monitor display screens to the monitor in communication with the computer, and
displaying, using the processor on the computer, the one of the plurality of monitor display screens on the monitor,
further wherein the one of the plurality of monitor display screens is equivalent to the output screen on the mobile device.

2. The one or more computer-readable medium of claim 1, wherein the wireless network is Bluetooth.

3. The one or more computer-readable medium of claim 1, wherein the computer readable instructions on the mobile device is written in j2me code.

4. The one or more computer-readable medium of claim 1, wherein the computer readable instructions on the computer is written in Microsoft C# code.

5. The one or more computer-readable medium of claim 1, wherein each of the output screens on the mobile device corresponds to one of the plurality of monitor display screens.

6. The one or more computer-readable medium of claim 1, wherein when the output screen changes to a new output screen, the computer-executable instructions cause the system to perform the following steps:
converting, using the processor on the mobile device, the new output screen from the mobile device into a second transferrable command,
sending, using the processor on the mobile device, the second transferrable command to the computer via the wireless network;
receiving, using the processor on the computer, the second transferrable command from the mobile device display application via the wireless network,
translating, using the processor on the computer, the second transferrable command into a second one of the plurality of monitor display screens,
sending, using the processor on the computer, the second one of the plurality of monitor display screens to the monitor in communication with the computer, and
displaying, using the processor on the computer, the second one of the plurality of monitor display screens on the monitor.

7. A method for displaying an output screen associated with a mobile device on a monitor of a computer, the method comprising:
connecting the mobile device to the computer via a network;
identifying, using the mobile device, a transferrable command associated with an output screen of the mobile device;
sending, using the mobile device, the transferrable command to the computer via the network;
receiving, using the computer, the transferrable command from the mobile device;
translating, using the computer, the transferrable command into one of a plurality of monitor display screens;
sending, using the computer, the one of the plurality of monitor display screens to a monitor in communication with the computer; and
displaying, using the computer, the one of a plurality of monitor display screens on the monitor,
wherein the one of the plurality of monitor display screens is equivalent to the output screen from the mobile phone.

8. The method of claim 7, wherein when the output screen on the mobile device changes to a second output screen, the method further comprises:
identifying, using the mobile device, a transferrable command associated with the second output screen of the mobile device;
sending, using the mobile device, the second transferrable command to the computer via the network;
receiving, using the computer, the second transferrable command from the mobile device;
translating, using the computer, the second transferrable command into a second one of the plurality of monitor display screens;
sending, using the computer, the second one of the plurality of monitor display screens to the monitor in communication with the computer; and
displaying, using the computer, the second one of the plurality of monitor display screens on the monitor.

9. The method of claim 7, wherein the network is wireless.

10. The method of claim 9, wherein the wireless network is Bluetooth.

11. The method of claim 7, wherein each of the output screens on the mobile device corresponds to one of the plurality of monitor display screens.

12. A method for displaying an output screen associated with a mobile device on a monitor of a master computer, the method comprising:
connecting the mobile device to the computer via a network;
identifying a transferrable command associated with an output screen of the mobile device;
sending the transferrable command to the master computer via the network;
receiving the transferrable command from the mobile device;
translating the transferrable command into one of a plurality of monitor display screens;
sending the one of the plurality of monitor display screens to at least monitor in the display network; and
displaying the one of the plurality of monitor display screens on at least one of the monitors in the display network,
wherein the one of the plurality of monitor display screens is equivalent to the output screen from the mobile phone.

13. The method of claim 12, wherein when the output screen on the mobile device changes to a second output screen, the method further comprises:
identifying a transferrable command associated with the second output screen of the mobile device;
sending the second transferrable command to the master computer via the network;
receiving the second transferrable command from the mobile device;
translating the second transferrable command into a second one of the plurality of monitor display screens;
sending the second one of the plurality of monitor display screens to at least one monitor in the display network; and
displaying the second one of the plurality of monitor display screens on the at least one of the monitors in the display network.

14. The method of claim 12, wherein the network is wireless.

15. The method of claim 14, wherein the wireless network is Bluetooth.

16. The method of claim 12, wherein each of the output screens on the mobile device corresponds to one of the plurality of monitor display screens.
